(19) United States
(12) Patent Application Publication
(10) Pub. No.: US 2026/0204544 A1
(43) Pub. Date: Jul. 16, 2026

(54) Negative Electrode for Lithium Secondary Battery and Lithium Secondary Battery Comprising Same

(71) Applicant: SK On Co., Ltd., Seoul (KR)

(72) Inventors: Sang-Won Bae, Daejeon (KR); Yong-Seok Lee, Daejeon (KR)

(21) Appl. No.: 19/135,952

(22) PCT Filed: Sep. 7, 2023
(86) PCT No.: PCT/KR2023/013383

§ 371 Date: Jun. 5, 2025

(30) Foreign Application Priority Data
Dec. 6, 2022 (KR) 10-2022-0169009

(51) Int. Cl. H01M 4/36; H01M 4/02; H01M 4/38; H01M 4/583; H01M 10/0525

(52) U.S. Cl. CPC H01M 4/364; H01M 4/386; H01M 4/583; H01M 10/0525; H01M 2004/027

(57) ABSTRACT

The present disclosure relates to a negative electrode for a lithium ion secondary battery and a secondary battery including the negative electrode, wherein the negative electrode includes a current collector; and a negative electrode mixture layer formed on at least one side of the current collector, wherein the anode mixture layer is divided into a plurality of regions in a plane, wherein the regions include a first region having a first negative electrode mixture composition and a second region having a second negative electrode mixture composition, and during discharge, the thickness of the negative electrode mixture layer in the first region is greater than the thickness of the negative electrode mixture layer in the second region.

### CROSS-REFERENCE TO RELATED APPLICATIONS

This application is the United States national phase of International Patent Application No. PCT/KR2023/013383 filed Sep. 7, 2023, and claims priority to Korean Patent Application No. 10-2022-0169009 filed Dec. 6, 2022, the disclosures of which are hereby incorporated by reference in their entireties.

### BACKGROUND

### Technical Field

The present disclosure relates to an anode for a lithium ion secondary battery and a secondary battery including the anode.

### Technical Considerations

Recently, as interest in environmental issues has increased, exhaust gases from vehicles using fossil fuels such as gasoline or diesel have been identified as one of the main causes of air pollution, and a large amount of research into electric vehicles (EVs), hybrid electric vehicles (HEVs) and the like is being conducted as a means to replace such vehicles.

In addition, lithium secondary batteries with high discharge voltage and output stability are mainly used as power sources for these electric vehicles (EVs) and hybrid electric vehicles (HEVs), and the like. In addition, as the need for high-energy secondary batteries with high energy density increases, development and research on high-capacity anodes for these batteries are also being actively conducted.

Recently, in order to implement high-capacity and high-energy density secondary batteries, anode composite compositions are being developed by mixing graphite, which was commonly used as an anode active material, with silicon-based active materials with high capacity per unit weight.

Such silicon-based active materials are effective in improving energy density due to their high capacity, but have the disadvantage of greater volume expansion compared to graphite during charge and discharge. Therefore, as the content of silicon-based active materials increases, energy density may be greatly improved, but the thickness of the battery increases when charging the battery, which increases the surface pressure on the battery module and pack, and the like, and various problems occur due to the application of silicon-based active materials.

The concept of the thickness expansion of the anode due to the charging of the battery is schematically illustrated in FIG. 1. As illustrated in (a) of FIG. 1, in an anode (10) including the silicon-based active material as the active material, an anode mixture layer (3) having a predetermined thickness expands in volume as illustrated in (b) of FIG. 1 according to the charging process of the battery, thereby increasing the thickness of an anode mixture layer (4).

Therefore, in applying a high-capacity silicon-based active material to improve the energy density of a lithium ion secondary battery, a technology that may control the problem due to the volume expansion during charging and discharging is strongly demanded.

### SUMMARY

In a non-limiting aspect of the present disclosure, provided is an anode and a secondary battery including the anode, in which energy density may be improved by using a silicon-based active material as an anode active material in the anode of a lithium ion secondary battery, and simultaneously, problems caused by volume expansion of the anode during charge and discharge due to the use of the silicon-based active material may be resolved.

In a non-limiting aspect of the present disclosure, an anode for a secondary battery is provided, and the anode includes a current collector; and an anode mixture layer formed on at least one surface of the current collector, wherein the anode mixture layer is divided into a plurality of regions with respect to a plane, the regions include a first region having a first anode mixture composition and a second region, having a second anode mixture composition different from the first anode mixture composition, and an anode mixture layer of the first region and an anode mixture layer of the second region have different thicknesses, based on discharging.

The number of the second region may be n (where n is a natural number greater than 1), and the number of the first region may be n+1.

The number of the first region may be 2 or more, and the second region may be located between adjacent first regions.

The region may be an odd number of 3 or more, and the first region may be located at a terminal region of the region.

The anode mixture layer of the second region among the first region and the second region may be thicker than the anode mixture layer of the first region.

The anode mixture layer of the first region may include a silicon-based active material, and the anode mixture layer of the second region may not include a silicon-based active material or may have a content less than the content of the silicon-based active material included in the anode mixture layer of the first region.

The silicon-based active material may be at least one selected from the group consisting of SiOx (0≤x<2), a Si—C composite, and a Si—Y alloy (wherein Y is an element selected from the group consisting of alkali metals, alkaline earth metals, transition metals, Group 13 elements, Group 14 elements, rare earth elements, and combinations thereof).

The anode mixture layer of the first region may have a silicon-based active material content of 1 to 30 wt %, and the anode mixture layer of the second region may have a silicon-based active material content of 10 wt % or less.

The anode mixture layer may include a carbon-based active material.

At least one of the anodes may have a thickness difference between the first region and the second region within 10% of a thickness of the first region, when fully charged.

According to another non-limiting aspect of the present disclosure, a secondary battery includes any one of the anodes above.

A thickness difference between the first region and the second region may be within 10% of a thickness of the first region, when fully charged.

According to non-limiting embodiments of the present disclosure, by including a silicon-based active material, the energy density may be improved, while controlling the problem of an increase in the thickness of the anode caused by the volume expansion of the silicon-based active material during charging and an increase in surface pressure resulting therefrom.

In addition, according to non-limiting embodiments of the present disclosure, a passage for the movement of the electrolyte is secured due to the gap according to the electrode step, the electrode wetting property is increased, and the movement of lithium ions may be improved, so that additional improvement in the output may be expected.

### BRIEF DESCRIPTION OF THE DRAWINGS

FIG. 1 is a drawing illustrating a cross-section of an anode including a silicon-based active material, and schematically illustrates a concept that the thickness of the anode increases as the silicon-based active material expands due to charging of the battery;

FIG. 2 is a drawing illustrating a cross-section of an anode according to non-limiting embodiments of the present disclosure, and schematically illustrates an anode, which includes two or more regions and in which the anode mixture layer is formed on the current collector and which has a step due to different thicknesses between anode mixture layers of respective regions;

FIG. 3 conceptually illustrates an anode in which the thickness of the electrode mixture layer of some regions increases as the silicon-based active material expands due to charging of the anode according to the embodiment illustrated in FIG. 2;

FIG. 4 is a drawing illustrating a schematic plane of an anode according to the embodiment illustrated in FIG. 2, and illustrates an example in which the widths of the first region and the second region are the same; and

FIG. 5 is a drawing schematically illustrating a cross-section of an anode according to non-limiting embodiments of the present disclosure, and schematically illustrates an anode in which the thicknesses of the anode mixture layers between two or more regions are different, thereby having a step, and the width of the first region is larger than the width of the second region.

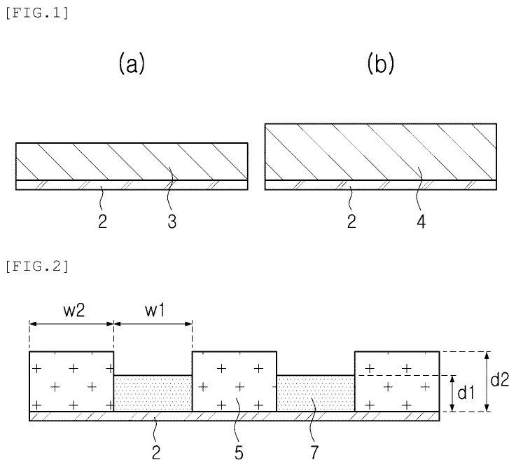

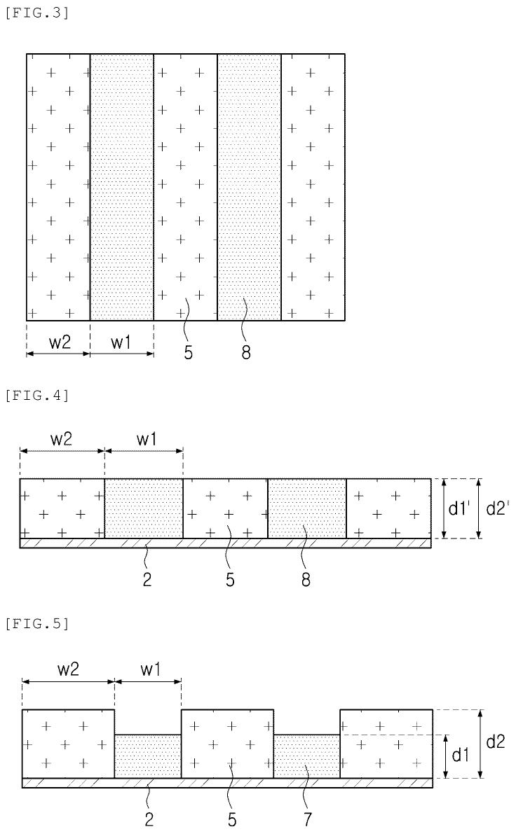

### DETAILED DESCRIPTION

The present disclosure is intended to provide an anode that may solve the problem of increased thickness of a battery due to volume expansion of a silicon-based anode active material during a charging process of a battery, in an anode that includes a silicon-based active material as an anode active material and seeks high energy density.

Hereinafter, non-limiting embodiments of an anode according to the present disclosure will be specifically described with reference to the attached drawings.

FIG. 2 schematically illustrates an anode provided by the present disclosure, and as illustrated in FIG. 2, an anode (10) according to the present disclosure includes an anode mixture layer on one or both surfaces of an anode current collector (2). FIG. 2 illustrates an example in which an anode mixture layer is formed only on one surface of an anode current collector (2), but is not limited thereto, and an anode mixture layer may be formed on both surfaces of an anode current collector (2).

The anode mixture layer may be formed to have multiple regions with respect to a plane. For example, the anode mixture layer may be divided into multiple regions in one direction in the plane of the anode current collector (2). For example, as illustrated in FIG. 2, the anode mixture layer may be divided into multiple regions from one end of the anode current collector (2) toward the opposite end, and first regions (5) and second regions (7) may be alternately formed.

At this time, the first region (5) and the second region (7) may form an anode mixture layer with an anode mixture composition having a different composition for each region. Specifically, the anode mixture layer formed in the first region (5) and the anode mixture layer formed in the second region (7) may be mixture layers having different volume expansion characteristics when the battery is charged. For example, the anode mixture layer of the first region (5) may have a large volume expansion characteristic when charged, and the anode mixture layer of the second region (7) may have a small volume expansion characteristic when charged.

Furthermore, the anode mixture layer of the first region (5) and the anode mixture layer of the second region (7) may have different thicknesses in consideration of the volume expansion characteristics of respective anode mixture layers. For example, the anode mixture layer of the first region (5) having a large volume expansion characteristic may be formed to have a thickness (d1) that is thin, and the anode mixture layer of the second region (7) having a small volume expansion characteristic may be formed to have a thickness (d2) thicker than the thickness (d1) of the anode mixture layer of the first region (5). More specifically, the thickness (d2) of the anode mixture layer of the second region (7) may be set by considering the degree to which the thickness (d1′) of the anode mixture layer of the first region (5) increases due to volume expansion when the battery is charged.

In this way, by making the thickness of the anode mixture layer of the first region (5) and the anode mixture layer of the second region (7) different, and by forming the anode mixture layer of the second region (7) with a maximum thickness (d1′) of the anode mixture layer of the first region (5) during charging, as illustrated in FIG. 4, even if the thickness (d1′) of the anode mixture layer of the first region (5) increases due to volume expansion during the charging process, the thickness (d2) of the anode mixture layer of the second region (7) may be maintained, thereby minimizing the thickness change in the entire anode (10), and ultimately preventing problems due to increased surface pressure applied to the battery case, module case, and pack.

In the case in which the surface pressure increases as described above, the module and/or pack expand, and if the module and pack cannot withstand the expansion, the structure of the module and/or pack may eventually collapse, resulting in destruction of the sealing property. Furthermore, even in the cell unit, if the pressure provided by the module and pack is lost, the adhesion of the electrodes in the battery decreases, which may result in performance degradation such as increased resistance, decreased capacity expression, decreased lifespan and the like.

Therefore, the anode mixture layer of the first region (5) may include a silicon-based active material to improve energy density, and the anode mixture layer of the second region (7) may not include the silicon-based anode active material.

As illustrated in FIG. 2, and in non-limiting embodiments, the first region (5) and the second region (7) may be formed alternately. In addition, the anode mixture layer of the second region (7) with a small thickness change may be arranged at both edges of the anode current collector (2). In this way, since the anode mixture layer of the second region (7) is located at the edge, i.e., the terminal region, even if the volume of the anode mixture layer of the first region (5) expands, it may induce expansion in the thickness direction and suppress volume expansion in the width direction.

More specifically, the sum of the first region and the second region, for example, the number of regions that the anode mixture layer has, may be an odd number of 3 or more, and when the anode mixture layer of the first region (5) is n (where n is a natural number), the number of the anode mixture layer of the second region (7) may be n+1. Therefore, the first region (5) may be located between adjacent second regions (7).

In non-limiting embodiments of an anode according to the present disclosure, the widths of the anode mixture layers of respective regions may be the same or different. For example, as illustrated in FIG. 4, the width (w1) of the first region and the width (w2) of the second region may be the same, and as illustrated in FIG. 5, the width (w1) of the first region may be smaller than the width (w2) of the second region.

If necessary, an anode mixture layer of a third region may be further included. The anode mixture layer of the third region may include a silicon-based anode active material, and the content of the silicon-based anode active material included in the anode mixture layer of the third region is not particularly limited. For example, if the content of the silicon-based active material included in the anode mixture layer of the third region is less than the content of the silicon-based anode active material included in the anode mixture layer of the first region, the thickness of the anode mixture layer of the third region may be formed thicker, thereby controlling the final thickness according to the thickness increase during charging to reach the thickness of the second anode mixture layer. Conversely, if the content of the silicon-based active material included in the anode mixture layer of the third region is greater than the content of the silicon-based anode active material included in the anode mixture layer of the first region, the thickness of the anode mixture layer of the third region may be formed to be thinner, thereby controlling the final thickness according to the thickness increase during charging to reach the thickness of the second anode mixture layer.

In the first region and the second region, the difference (d1′-d2′) between the thickness (d1′) of the first region and the thickness (d2′) of the second region at full charge may be 0 (when the thicknesses of the first region and the second region are the same) or greater than 0, and may be less than the difference (d1-d2) between the thickness (d1) of the first region and the thickness (d2) of the second region at the initial (before charging) time. At this time, d1 and d2 are not the same, the thickness of d1 is greater than d2, and d1 and d1′ may be the same. If this is expressed as a formula, it may be expressed as the following formula (1).

$$0 \leq ( d {1}^{′} - d {2}^{′} ) / ( d 1 - d 2 ) < 1 \qquad ( 1 )$$

More specifically, the formula (1) may be 0 or more and 0.3 or less, 0 or more and 0.5 or less, or 0 or more and 0.7 or less.

In non-limiting embodiments of the present disclosure, the anode mixture layer of the first region have the same thickness as the anode mixture layer of the second region based on the full charge, and the smaller the thickness difference between the anode mixture layer of the first region and the anode mixture layer of the second region, the more preferable it is. More specifically, but not limited thereto, the thickness difference may be, for example, 10% or less, specifically 5% or less, or more specifically 3% or less, based on the thickness of the anode mixture layer of the first region.

In the case in which the thicknesses of the first region and the second region are identically changed by charging, the above equation (1) is 0, and may also be expressed as the following equation (2).

$$Initial thickness ( d 1 ) of first region \times ( 1 + thickness increase rate of first region when fully charged ) = Initial thickness ( d 2 ) of second region \times ( 1 + thickness increase rate of second region when fully charged ) \qquad ( 2 )$$

In non-limiting embodiments of the present disclosure, the silicon-based active material is not limited thereto, but for example, may be at least one selected from the group consisting of SiOx (0≤x<2), a Si—C composite, and a Si—Y alloy (wherein Y is an element selected from the group consisting of alkali metals, alkaline earth metals, transition metals, Group 13 elements, Group 14 elements, rare earth elements, and combinations thereof), and more specifically, may be SiOx.

In non-limiting embodiments of the present disclosure, the anode mixture layer of the first region may include, but is not limited thereto, a silicon-based active material in an amount of 1 to 30 wt % among the anode mixture layers of the first region.

Furthermore, the anode mixture layer of the first region may further include a carbon-based anode active material. The carbon-based anode active material may be used without special restrictions if it is commonly used as an anode active material, and for example, it may be one or more selected from the group consisting of artificial graphite, natural graphite, and graphitized mesocarbon microbeads, and more specifically, artificial graphite may be used, and artificial graphite and natural graphite may be used in combination.

In addition, the anode mixture layer of the first region may include a binder for binding between anode active materials and binding between the anode current collector and the anode mixture layer. As the binder, at least one selected from the group consisting of a rubber-based binder and a water-soluble polymer-based binder may be used.

The rubber-based binder may be one that does not dissolve in an aqueous solvent such as water or the like, but has water-dispersibility that enables smooth dispersion in an aqueous solvent, and may include at least one selected from, for example, styrene butadiene rubber (SBR), hydrogenated nitrile butadiene rubber (HNBR), acrylonitrile butadiene rubber, acrylic rubber, butyl rubber, and fluoro rubber. Specifically, in terms of ease of dispersion and excellent phase stability, the binder may include at least one selected from the group consisting of styrene butadiene rubber and hydrogenated nitrile butadiene rubber, and more specifically, styrene butadiene rubber.

In addition, the water-soluble polymer binder may be dissolved in an aqueous solvent such as water or the like, and may include at least one selected from polyvinyl alcohol (PVA), polyacrylic acid (PAA), polyethylene glycol (PEG), polyacrylonitrile (PAN), polyacryl amide (PAM), and carboxylmethyl cellulose (CMC).

The binder is not limited thereto, but may be included in an amount of 20 wt % or less, for example, 0.1 wt % or more, 0.5 wt % or more, 1 wt % or more, 1.5 wt % or more, 2 wt % or more, or 3 wt % or more, and in an amount of 20 wt % or less, 15 wt % or less, 10 wt % or less, 7 wt % or less, or 5 wt % or less, based on the total weight of the anode mixture layer of the first region. Meanwhile, the rubber-based binder and the water-soluble polymer-based binder may be mixed and used, and in this case, the rubber-based binder and the water-soluble polymer-based binder may be included independently in a weight ratio of 1 to 99:99 to 1, and may be included in various weight ratios such as, for example, 1 to 95:95 to 1, 25 to 75:75 to 25, and the like.

In addition, the anode mixture layer of the first region may include a conductive agent to improve conductivity. When the conductive agent is included, there is no particular limitation, but for example, one or more selected from the group consisting of graphite, carbon black, carbon nanotubes, metal powder, and conductive oxides may be used. More specifically, carbon nanotubes may be used, and exfoliation due to volume expansion of the silicon-based active material may be more effectively prevented.

The conductive agent may be included in an amount of 20 wt % or less, for example, 0.5 wt % or more, 0.7 wt % or more, 1 wt % or more, 1.2 wt % or more, or 1.5 wt % or more, and in an amount of 20 wt % or less, 15 wt % or less, 10 wt % or less, 7 wt % or less, or 5 wt % or less, based on the total weight of the anode mixture layer of the first region.

Meanwhile, the anode mixture layer of the second region includes a carbon-based anode active material, a binder, and may also include a conductive agent if necessary. The anode active material, binder, and conductive agent are as described above, and their description is omitted.

The anode mixture composition of the anode mixture layer of the second region is not limited thereto, and may include an anode active material, a binder, and a conductive agent as needed in the same content as the anode mixture composition of the anode mixture layer of the first region.

Meanwhile, the anode mixture layer of the second region may include a carbon-based active material such as graphite as the anode active material, may not include a silicon-based active material, and when it includes a silicon-based active material, it may include a content less than the content of the silicon-based active material included in the anode mixture layer of the first region. For example, the content of the silicon-based active material in the anode mixture layer of the second region may be 10 wt % or less.

Meanwhile, when the anode mixture layer of the third region is included, it may include components included in the anode mixture layer of the first region, and the content of the silicon-based anode active material included in the anode mixture layer of the first region may be controlled. In addition, the anode mixture layer of the third region may include a silicon-based active material having a different volume expansion rate from the silicon-based anode active material included in the first region.

Non-limiting embodiments of the anode of the present disclosure as described above may improve energy density by including a silicon-based active material, and may control the problem of an increase in the thickness of the anode and an increase in surface pressure caused by the volume expansion of the silicon-based active material during charging.

Furthermore, the secondary battery including non-limiting embodiments of the anode of the present disclosure may prevent a problem caused by an increase in surface pressure due to a change in the thickness of the anode due to the volume expansion of the active material during the charge/discharge process of the battery, despite including a silicon-based active material included as an anode active material in the anode.

Hereinafter, the present disclosure will be described in more detail with reference to examples. The following examples are examples of the present disclosure and are not intended to limit the scope of the present disclosure.

### Example 1

A first anode mixture slurry composed of 76 wt % graphite, 1 wt % conductive agent, and 3 wt % binder as a carbon-based anode active material with 20 wt % Si was manufactured. In addition, a second anode mixture slurry composed of 96 wt % graphite, 1 wt % conductive agent, and 3 wt % binder as a carbon-based anode active material was manufactured.

As an anode current collector, the first anode mixture slurry and the second anode mixture slurry were alternately applied in a vertical direction to one surface of a copper foil (5 cm wide×6 cm long), thereby manufacturing an anode in which the anode slurry coating layers of the first anode mixture slurry and the second anode mixture slurry were alternately arranged in a stripe shape.

At this time, the width of the anode mixture coating layer in the stripe shape by the first and second anode mixture slurries was uniformly formed to 1 cm each, forming a total of 5 stripes.

The anode mixture coating layer was dried and rolled to manufacture an anode. The thickness of the mixture layer of the manufactured anode was measured, and the thickness of the first region by the first anode mixture coating layer was 110 μm, and the thickness of the second region by the second anode mixture coating layer was 132 μm.

A battery was manufactured using the manufactured anode, and after fully charging (full charging), the battery was disassembled to measure the thickness of the anode swollen by the charging, and the thickness increase rate of each region was calculated, which is illustrated in Table 1 below.

TABLE 1

| Initial | Initial | Thickness of | Thickness of |
|---|---|---|---|
| Thickness of | Thickness of | First Region | Second Region |
| First Region | Second Region | after Full Charge | after Full |
| (μm) | (μm) | (μm) | Charge (μm) |
| 110 | 132 | 165 | 165 |

From the above Table 1, when calculating from each thickness before charging and after full charging, the thickness increase rate of the first region was 50% [=(165−110)×100/110], and the thickness increase rate of the second region was 25% [=(165-132)×100/132]. When calculating Equation 1 using the thickness increase rate of each region according to the above calculation, it can be seen that the equation of Equation 1 is satisfied. Initial thickness (d1) of first region×(1+thickness increase rate of first region when fully charged)=Initial thickness (d2) of second region×(1+thickness increase rate of second region when fully charged) (1)

$$110 µm \times ( 1 + 0.5 ) = 132 µm \times ( 1 + 0.25 )$$

1. An anode comprising:
a current collector; and an anode mixture layer formed on at least one surface of the current collector,
wherein the anode mixture layer is divided into a plurality of regions with respect to a plane,
the regions comprise a first region having a first anode mixture composition and a second region, having a second anode mixture composition different from the first anode mixture composition, and
an anode mixture layer of the first region and an anode mixture layer of the second region have different thicknesses, based on discharging.

2. The anode of claim 1, wherein the number of the second region is n, and the number of the first region is n+1, where n is a natural number greater than 1.

3. The anode of claim 1, wherein the number of the first region is 2 or more, and the second region is located between adjacent first regions.

4. The anode of claim 1, wherein the region is an odd number of 3 or more, and the first region is located in a terminal region of the anode mixture layer.

5. The anode of claim 1, wherein the anode mixture layer of the second region among the first region and the second region is thicker than the anode mixture layer of the first region.

6. The anode of claim 5, wherein the anode mixture layer of the first region comprises a silicon-based active material, and the anode mixture layer of the second region does not comprise a silicon-based active material.

7. The anode of claim 5, wherein the anode mixture layer of the first region comprises a silicon-based active material, and the anode mixture layer of the second region comprises silicon-based active material in a smaller amount than the anode mixture layer of the first region.

8. The anode of claim 6, wherein the silicon-based active material is at least one selected from the group consisting of SiOx, 0≤x<2; a Si—C composite; and a Si—Y alloy, where Y is an element selected from the group consisting of alkali metals, alkaline earth metals, transition metals, Group 13 elements, Group 14 elements, rare earth elements, and combinations thereof.

9. The anode of claim 76, wherein the anode mixture layer of the first region has a silicon-based active material content of 1 to 30 wt %, and the anode mixture layer of the second region has a silicon-based active material content of 10 wt % or less.

10. The anode of claim 1, wherein the anode mixture layer includes a carbon-based active material.

11. The anode of claim 1, wherein a thickness difference between the first region and the second region is within 10% of a thickness of the first region, when fully charged.

12. A secondary battery comprising the anode according to claim 1.

13. The secondary battery of claim 12, wherein a thickness difference between the first region and the second region is within 10% of a thickness of the first region, when fully charged.

14. A secondary battery comprising the anode according to claim 2.

15. The secondary battery of claim 14, wherein a thickness difference between the first region and the second region is within 10% of a thickness of the first region, when fully charged.

16. A secondary battery comprising the anode according to claim 3.

17. The secondary battery of claim 16, wherein a thickness difference between the first region and the second region is within 10% of a thickness of the first region, when fully charged.

18. A secondary battery comprising the anode according to claim 4.

19. The secondary battery of claim 18, wherein a thickness difference between the first region and the second region is within 10% of a thickness of the first region, when fully charged.

20. A secondary battery comprising the anode according to claim 5.
